(19) United States
(12) Patent Application Publication
(10) Pub. No.: US 2011/0107368 A1
(43) Pub. Date: May 5, 2011

(54) Systems and Methods for Selecting Ad Objects to Insert Into Video Content

(75) Inventors: Alan S. Rouse, Lawrenceville, GA (US); Charles H. Dasher, Lawrencveville, GA (US); Hugh Watkins, Canton, GA (US)

(73) Assignee: Tandberg Television, Inc.

(21) Appl. No.: 12/611,377

(22) Filed: Nov. 3, 2009

(51) Int. Cl. H04N 7/10

(52) U.S. Cl. 725/34

(57) ABSTRACT

Various embodiments of the present invention relate to systems and methods for selecting ad objects to insert into video content. In particular embodiments, the systems and methods identity an object in video content that may be used to display an ad object and select an ad object to insert in place of the object in the video content. As a result, the ad object is displayed in the video content for the identified object when the video content is viewed.

### BACKGROUND OF THE INVENTION

1. Field of the Invention

The disclosed invention generally relates to systems and methods for identifying and selecting advertisement (ad) objects to insert into video content, and more specifically, to systems and methods to identify an object in video content that may be used to display an ad object and to select an ad object to insert in place of the object in the video content so that the ad object is displayed when the video content is viewed.

2. Description of the Related Art

Product placement and advertising within video content is prevalent. For example, many individuals remember Elliott luring E.T. with Reese's Pieces® from the shed in the backyard in the movie “E.T. the Extra-Terrestrial.”® However, as time passes, many of these advertisements become stale. For instance, many James Bond movies include product placement of a popular car model that is driven by James Bond at the time the movies are released in theaters. However, after a number of years, these models may loss their popularity or may not even be produced anymore.

As a result, many video content distributors and companies advertising products may wish to replace products and advertisements that appear in older content with newer products and advertisements. In addition, content distributors and companies advertising products may wish to insert product and advertisements into video content in areas that did not originally display advertising. For example, a movie may contain a scene in which a large brick wall is located in the background. In this instance, a distributor or company may wish to insert an advertisement in the movie so that it is displayed on the brick wall during the particular scene. Furthermore, in many instances, it may be desirable to replace these products and advertisements on-the-fly, that is, as the video content is being streamed for viewing. This provides the freedom of replacing/inserting advertisements in video content dynamically and often. Therefore, a need exists to identify objects in video content that may be used to display advertisements and to select advertisements to insert in place of these objects in the video content so that the advertisements are displayed when the video content is viewed. Further, a need exists for a solution to provide these advertisements to be inserted into video content on-the-fly while the content is being delivered by a content provider to be streamed for viewing.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is a flow diagram illustrating the process for inserting ad objects into a video content according to various embodiments of the invention.

FIG. 2 is a schematic diagram illustrating a service provider system, an ad object creator system, and an avail object creator system according to various embodiments of the invention.

FIG. 2A is a schematic diagram illustrating the components of a service provider system according to various embodiments of the invention.

FIG. 3 is a schematic diagram illustrating an ad object selection server according to various embodiments of the invention.

FIG. 4 is a flow diagram of an avail object creation tool according to various embodiments of the invention.

FIG. 5 is a flow diagram of an ad object creation tool according to various embodiments of the invention.

FIG. 6 is a flow diagram of an ad object selection module according to various embodiments of the invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Like numbers refer to like elements throughout.

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### BRIEF OVERVIEW OF AN EMBODIMENT

Various embodiments of the present invention provide systems and methods for selecting ad objects to insert into video content. Further, in various embodiments, this entails the systems and methods identifying an object in video content that may be used to display an ad object and selecting an ad object to insert in place of the object in the video content so that the ad object is displayed when the video content is viewed. For purposes of this disclosure, “video content” is a particular video media. For instance, video content may be a television program and/or a movie. Furthermore, the term “provider” is used from this point forward to indicate a cable service provider, a satellite TV provider, or any other provider of distributed video content. The term “object” or “video object” is an entity in a video scene that can be accessed (seek, browse) and manipulated (cut and paste). (See International Standard ISO/IEC 14496-2.20004(E).) An instance of a video object at a given frame is a “video object plane.” Using video segmentation, each frame of an input video sequence may be segmented into a number of video object planes (VOPs). Each VOP describes the physical object across the video sequence.

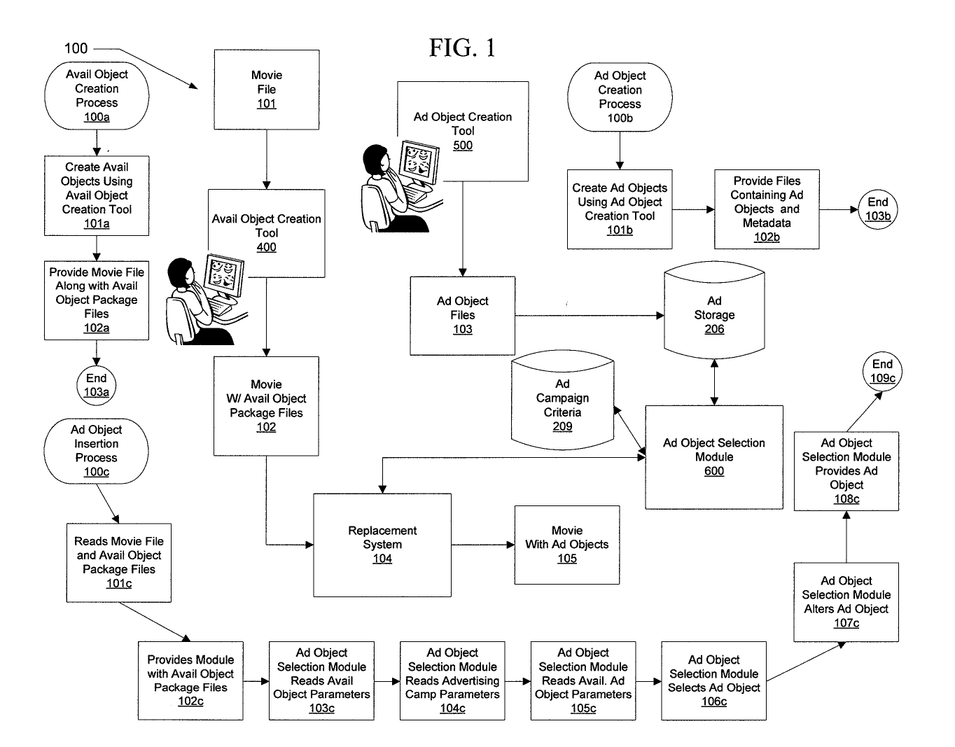

FIG. 1 illustrates one embodiment of a flow diagram of a process 100 for inserting an advertisement (e.g., ad) object into video content. This process 100 is broken down into three sub-processes, i.e., available (e.g., avail) object creation process 100a, ad object creation process 100b, and ad object insertion process 100c. The avail object creation process 100a is the process for creating avail object packages that represent objects in the video content that an ad object may replace. This process 100a begins with Step 101a of creating the avail objects using the avail object creation tool 400.

For instance, in one embodiment, an avail object creator working for a movie distributor reviews a movie file 101 using the avail object creation tool 400. In various embodiments, the movie file 101 may be of different types of formats; however the preferred embodiment uses an MPEG format. In various embodiments, the avail object creation tool 400 is a software and/or hardware component that is executed on a computer. For instance, in one embodiment, the avail object creation tool 400 is a graphical user interface (GUI) software package. The avail object creator views the movie using the GUI and identifies an object in a video sequence (e.g., a set of consecutive video frames) that either: (1) displays an advertisement; or (2) could display an advertisement. For example, the avail object creator may be reviewing a scene in the movie that has a billboard on the side of a road in the background of the scene. The GUI tracks the object through the video sequence and records the boundaries, shape, motion, and texture of the object over the video sequence. In various embodiments, the GUI may also be configured to record additional parameters for the particular object, such as, for example, perspective changes of the object through the scene and/or color palette used by the object. These parameters help to define the object (e.g., billboard) over the sequence of the movie. Further, the avail object creator may define additional parameters as needed. For instance, the avail object creator may define the historical period that is associated with the scene. For example, the movie may be a World War II movie and the avail object creator may define a period parameter that indicates the story in the movie takes place in the early 1940s.

Once the avail object creator has completed defining the parameters, the avail object creator selects a “save” button on the avail object creation tool 400. In response, the avail object creation tool saves the parameters, along with a sample of the video content surrounding the particular object in the movie sequence (e.g., video frames), as an avail object package. As is described in further detail below, this avail object package is used to help determine what ad object should be selected to insert into the movie (e.g., replace in the movie) for the particular object associated with the avail object package and to help locate the object in the movie file 101.

In various embodiments, the avail object creator repeats this process for each video object in the movie identified as a candidate to display an advertisement. Thus, once the avail object creator has defined all of the avail object packages, the avail object creator selects a “save packages” button on the avail object creation tool 400 and the tool 400 saves all of the packages into one or more avail object package files for the particular movie. Finally, in Step 102a, the movie and avail object package files 102 are provided to a content provider, such as a cable service provider.

The next set of steps in the process 100 involves the steps associated with the ad object creation process 100b. This particular process 100b involves creation of the ad objects that are to be inserted into video content (e.g., movie 101). In various embodiments, the ad object creation process 100b may be performed independent of the avail object creation process 100a. However, in particular embodiments, the avail object package files 102 may be used in conjunction with the ad object creation tool 500 to create the ad objects. Thus, in these particular embodiments, the ad object creation process 100b is performed after the avail object creation process 100a has been completed.

The process 100b begins at Step 101b with creating ad objects using the ad object creation tool 500. Similar to the avail object creation tool 400, the ad object creation tool 500 in various embodiments is a software and/or hardware component that is executed on a computer. In various embodiments, an ad object creator working for an advertiser/business uses the ad object creation tool 500 to create ad objects that can be inserted into the movie for each of the avail objects defined for the movie. Further, in particular embodiments, the ad object creator uses the ad object creation tool 500 to define a number of parameters for each ad object. Such as, for example, shape of the ad object, dimensions of the ad object, color palette used for the ad object, and what colors within the ad object are locked and cannot be changed. In addition, the ad object creator may also define parameters that provide guidance on how the ad object should be used in a movie. For instance, similar to the avail objects, the ad object creator may indicate in a parameter defining a historical period of time for which the ad object was designed to match, such as the 1970s or 1980s. Further, in various embodiments, the ad object creator may create ad objects as generic ad objects or may create ad objects for particular movies. For instance, in various embodiments, the ad object creator may download the avail object package files 102 for a particular movie 101 and create ad objects based on the avail objects packages contained in the files 102.

Further, in various embodiments, the ad object creation tool 500 may include a feature that allows the ad object creator to review what the ad object will look like in the movie 101 for a particular avail object. In these particular embodiments, the ad object creation tool 500 is configured to use the sample of video content surrounding the particular object saved in the avail object package to reconstruct the scene with the ad object inserted into the scene for the particular object. This provides the ad object creator a mechanism in which to review the particular ad object and to determine whether he or she needs to further edit the design of the ad object and/or further define parameters for the ad object.

In various embodiments, once the ad object creator has created the ad object and has defined the associated parameters, the ad object creator selects a “save” button on the ad object creation tool 500 and the tool 500 saves the ad object and associated parameters (e.g., metadata) into one or more files 103. The files 103 may contain only one ad object or may contain more than one ad object. Further, the files 103 may identify a particular movie 101 the ad object was created for or may identify that the ad object may be used in a number of movies (e.g., generic). Once the ad object creator has created all the ad objects, in Step 102b, the ad object creator provides the ad object files 103 to various parties for use. For instance, in various embodiments, the ad object creator provides the ad object files 103 to a content provider (e.g., cable service provider). For example, the ad object creator may store the ad object files 103 in a storage medium 206 that is accessible by various providers or may provide a copy of the files 103 to a particular content provider and the provider stores the ad object files 103 in storage medium 206 within the provider's system

The next set of steps in the process 100 involves the steps associated with the ad object insertion process 100c. This particular process 100c involves selecting ad objects for avail objects associated with particular video content and inserting the ad objects into the video content (e.g., movie 101) in place of the objects corresponding to the avail objects. In various embodiments, the movie distributor, advertiser/company, and/or content provider may enter into contractual agreements as to what ad objects are to be inserted into the movie 101 when broadcasted by the content provider. For instance, the distributor or the content provider may enter into an agreement with Coca Cola® to insert a Coke® ad object into the movie 101 as a billboard. In addition, the parties may also define restrictions for inserting ad objects into the movie. Such as, for example, restrictions on the content of the ad object, the historical time period the ad object must apply to, and the number of times the ad object is to be displayed in content. Thus, in various embodiments, the content provider may receive and/or may create and may store advertising campaign criteria (e.g., parameters) in some type of storage medium 209 that apply to particular movies and/or particular ad objects.

The content provider then sets up the movie 101 in its system to broadcast (or unicast) over its distribution network. For instance, the content provider schedules the movie to be broadcast over a certain channel in its distribution network for a particular time slot. In various embodiments, the content provider's system includes a replacement system 104 that is configured to replace a video object in a movie sequence with an ad object. In particular embodiments, the replacement system 104 is able to insert the ad objects into the movie on-the-fly as the movie is being streamed over the content provider's distribution network. Further, in various embodiments, the content provider's system includes an ad object selection module 600.

Therefore, in Step 101c, the content provider's system reads the movie file 101 and the avail object package files 102. In particular embodiments, the system (e.g., replacement system 104) provides the avail object package files to the ad object selection module 600, shown as Step 102c. In Step 103c, the ad object selection module 600 reads an avail object package from the avail object package files 102 and reads the parameters for the particular avail object. Further, in Step 104c, the ad object selection module 600 reads advertising campaign criteria (e.g., parameters) from the storage 209. In Step 105c, the ad object selection module 600 reads the parameters for the available ad object from the advertisement storage 206. In particular embodiments, this may entail the ad object selection module 600 querying the storage 206 to first identify the available ad objects, reading the files stored for the ad objects identified in the query, and then reading the parameters stored in the files. Further, in particular embodiments, the query may be based on parameters corresponding to the particular avail object and/or parameters corresponding to the advertising campaign criteria retrieved for the particular movie and/or particular avail object.

In Step 106c, the ad object selection module 600 selects an ad object for the particular avail object package. For instance, in various embodiments, the ad object selection module 600 uses (e.g., compares) the advertising campaign criteria parameters, the parameters in the avail object package, and the parameters for the available ad objects to select an ad object to insert into the movie. For example, the advertising campaign criteria parameters may indicate to insert a Coca Cola ad object for the particular avail object. The parameters for the avail object may indicate that the object associated with the particular avail object is rectangular in shape. Further, the parameters for the available ad objects may indicate whether each ad object is a “physical type” ad object (e.g., a soda can) or a “literature type” ad object (e.g., a magazine advertisement). Thus, the ad object selection module 600 compares these parameters with the parameters of the available Coca Cola ad objects found in the ad storage 206 to select an appropriate ad object to insert for the object in the movie.

Further, in particular embodiments, the ad object selection module 600 may alter the selected ad object based on the parameters, shown as Step 107c. For example, the ad object selection module 600 alters the ad object to display shadows and/or to change the perspective based on parameters in the avail object package that provide descriptions of the scene the ad object is to be displayed in. Finally, in Step 108c, the ad object selection module 600 provides the replacement system 104 with the ad object along with appropriate information (such as, for example, the boundaries, shape, motion, and texture of the object over the video sequence) so that replacement system 104 can locate the video object in the movie sequence and replace the video object with the ad object.

The content provider's system then streams the movie with the ad object 105 over the provider's distribution network. In various embodiments, the replacement system 104 may insert the ad objects on-the-fly as the movie 101 is being provided to stream over the provider's distribution network or may process the movie 101 first to insert the ad objects and then provide the movie 105 to be streamed once all of the ad objects have been inserted. As a result, the movie is distributed along with the ad objects displayed in the movie.

### Systems Architecture

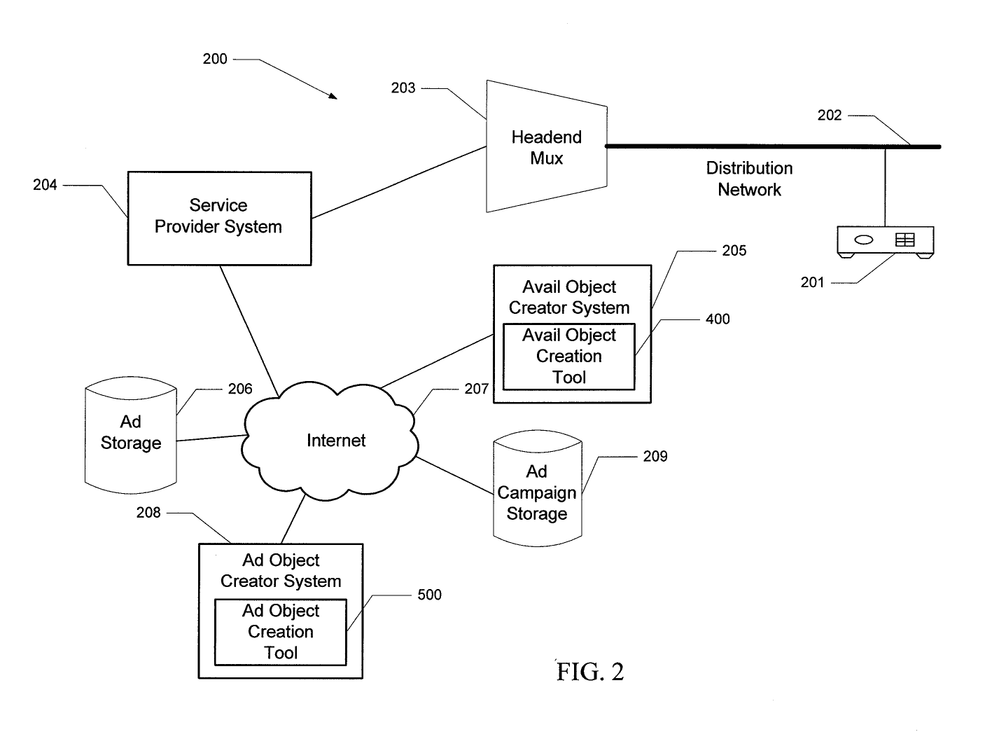

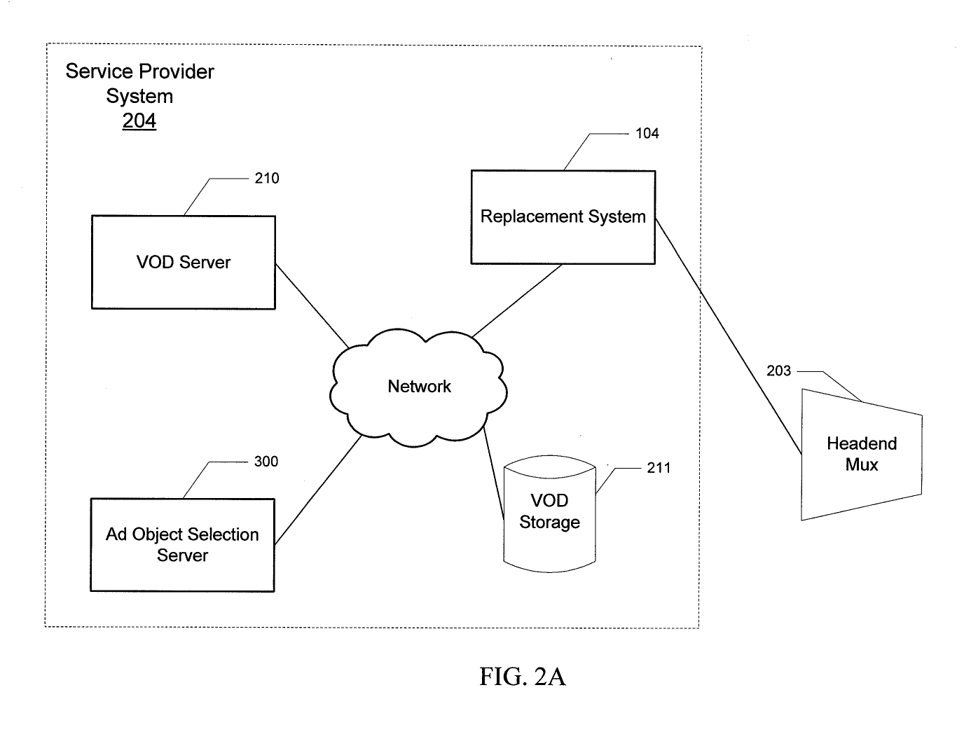

A configuration of systems 200 according to various embodiments of the invention is shown in FIG. 2. The configuration 200 shown in FIG. 2 includes a service provider system 204, an avail object creator system 205, and an ad object creator system 208. The service provider system 204 may be a cable provider's system providing cable programming to the cable provider's subscribers. However, the system 204 may also be a satellite TV provider's system or other providers of video programs.

In various embodiments, the avail object creator system 205 includes a tool 400 used to create avail objects for particular video content (as is described in further detail below). Further, in various embodiments, the avail object creator system 205 may be a system developed and used by various entities. For example, in one embodiment, the system 205 may be a video production company's system and the video production company may use the avail object creation tool 400 to identify possible objects in video content the video production company produces that can display advertisements.

In addition, in various embodiments, the ad object creator system 208 includes a tool 500 used to create ad objects for video content (as is described in further detail below). Similar to the avail object creator system 205, in various embodiments, the object creator system 208 may also be a system developed and used by various entities. For example, in one embodiment, the system 208 may be an advertising agency's system and the agency may use the ad object creation tool 500 to create and develop ad objects that can be inserted into video content.

It should be understood that components of each of the systems 204, 205, 208 may be combined with other components in other systems 204, 205, 208 in various embodiments. For instance, the avail object creation tool 400 and the ad object creation tool 500 may be located in the same system. Such as, in one embodiment, the service provider system 204 may also include the avail object creation tool 400 and the ad object creation tool 500. In this particular embodiment, the configuration of systems 200 may only include the service provider system 204 and not the avail object creator system 205 and the ad object creator system 208. Therefore, the system 200 depicted in FIG. 2 is provided for illustrative purposes only and should not be construed to limit the scope of the claimed invention.

In addition, in various embodiments, the systems 205, 205, 208 are connected over a communication channel. For instance, in FIG. 2, the systems 205, 205, 208 are connected over the Internet 207. However, it should be obvious to those of ordinary skill in the art, in light of this disclosure, that the systems 204, 205, 208 may use other channels of communication in other embodiments, such as a local area network (LAN), a wide area network (WAN), or a wireless network.

As shown, in various embodiments, the service provider system 204 communicates with a headend 203. Further, the headend 203 is in communication with a distribution network 202 and streams content over the distribution network 202 to one or more set-top boxes 201. In general, a set-top box 201 is a device that is used by a subscriber of the service provider to receive digital cable signals for television and is configured to send data to the headend 203. For example, the set-top box 201 may be a personal video recorder (PVR) provided by a cable company. The PVR receives the digital cable signal and feeds the signal into an individual's television set so that the individual can view the cable company's cable television programming.

In addition, the configuration of systems 200 may also include storage medium, such as ad storage 206 and ad campaign storage 209. This storage 206, 209 may also be connected via the network 207 and may communicate with other systems 204, 205, 208. While in other embodiments, the storage 206, 209 may be located within one of the systems 204, 205, 208. For example, the ad storage 206 may be located within the ad object creation system 208. As described in further detail below, in various embodiments, the ad storage 206 may store ad objects that may be inserted into video content and the ad campaign storage 209 may store advertising campaign criteria that may be used to identify one or more candidate ad objects to insert into the video content.

In various embodiments, the components of the systems 204, 205, 208 may be one or more devices or may include one or more devices executing software programs. Furthermore, in various embodiments, the storage medium 206, 209 may be one or more types of medium such as hard disks, magnetic tapes, or flash memory.

### Exemplary Service Provider System

The service provider system 204 depicted in FIG. 2 may be comprised of several components according to various embodiments. Accordingly, FIG. 2A shows a schematic diagram of a service provider system 204 according to one embodiment. In FIG. 2A, the service provider system 204 includes a replacement system 104, a VOD server 210, VOD storage 211, and an ad object selection server 300. In this particular embodiment, the components are in communication over a network 212. As describe in further detail below, the ad object selection server 300 includes a module that is configured to select an object to insert into video content being streamed by the service provider to its subscribers. Thus, in various embodiments, the VOD server 210 retrieves video content from the storage 211 and sends the content over the network 212 to the replacement system 104 to stream to subscribers. Further, the ad object selection server 300 (e.g., ad object selection module) selects an ad object to insert into the content and sends the ad object over the network 212 to the replacement system 104. In response, the replacement system 104 receives the video content and the ad object, inserts the ad object into the video content, and sends the video content with the inserted ad object to the headend 203. The headend 203 then streams the video content over the distribution network 202 to various subscribers.

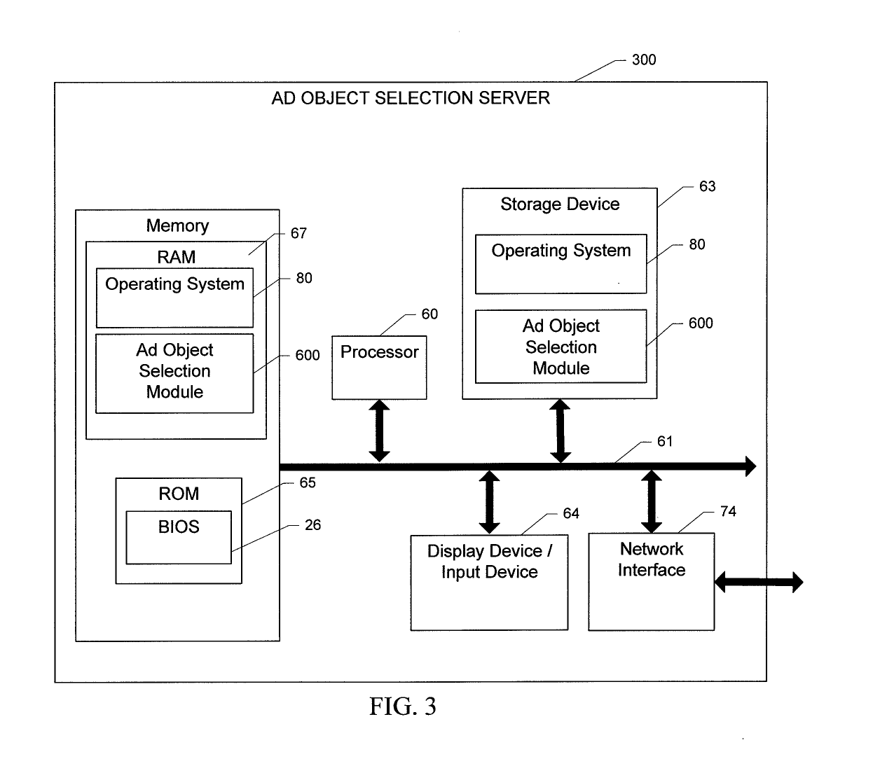

Accordingly, FIG. 3 shows a schematic diagram of the ad object selection server 300 according to one embodiment of the invention. However, it should be understood that the service provider system 204 does not necessarily need to include only a single server. For instance, in various embodiments, the system 204 may include one or more servers executing one or more software applications. Thus, the server 300 shown in FIG. 3 is provided for illustrative purposes only and should not be construed to limit the scope of the invention.

In FIG. 3, the ad object selection server 300 includes a processor 60 that communicates with other elements within the server 300 via a system interface or bus 61. Also connected to the server 300 is a display device/input device 64 for receiving and displaying data that may be used by administrative personnel. This display device/input device 64 may be, for example, a keyboard or pointing device that is used in combination with a monitor. The server 300 further includes memory 66, which preferably includes both read only memory (ROM) 65 and random access memory (RAM) 67. The server's ROM 65 is used to store a basic input/output system 26 (BIOS), containing the basic routines that help to transfer information between elements within the server 300. Alternatively, the server 300 can operate on one computer or on multiple computers that are networked together.

In addition, the server 300 includes at least one storage device 63, such as a hard disk drive, a floppy disk drive, a CD Rom drive, flash drive, or optical disk drive, for storing information on various computer-readable media, such as a hard disk, a removable magnetic disk, or a CD-ROM disk. As will be appreciated by one of ordinary skill in the art, each of these storage devices 63 is connected to the server bus 61 by an appropriate interface. The storage devices 63 and their associated computer-readable media provide nonvolatile storage for the server 300. It is important to note that the computer-readable media described above could be replaced by any other type of computer-readable media known in the art. Such media include, for example, magnetic cassettes, flash memory cards, digital video disks, and Bernoulli cartridges.

A number of program modules (e.g., set of computer program instructions) may be stored by the various storage devices and within RAM 67. For example, as shown in FIG. 3, program modules of the server 300 may include an operating system 80 and an ad object selection module 600. This module 600 may be used to control certain aspects of the operation of the server 300, as is described in more detail below, with the assistance of the processor 60 and an operating system 80.

Also located within the server 300 is a network interface 74, for interfacing and communicating with other elements of one or more networks (such as the network 212 described in the configuration of the service provider systems 204 depicted in FIG. 2A.) It will be appreciated by one of ordinary skill in the art that one or more of the server's 300 components may be located geographically remotely from other server 300 components. Furthermore, one or more of the components may be combined, and additional components performing functions described herein may be included in the server 300.

Similar to the service provider system 204, in various embodiments, the avail object creator system 205 and the ad creator system 208 may also comprise one or more servers. These servers may be similar to the server described FIG. 3 and may include the avail object creation tool 400 and/or the ad object creation tool 500.

### Exemplary System Operation

As mentioned above, the configuration of systems 200 according to various embodiments identify an object in video content that may be used to display an ad object and select an ad object to insert in place of the object in the video content so that the ad object is displayed when the video content is viewed. In various embodiments, the configuration of systems 200 includes a service provider system 204, an avail object creator system 205, and an ad object creator system 208. In particular embodiments, the service provider system 204 includes an ad object selection server 300 that includes a module 600 that is configured to select an ad object to insert into video content (such as a movie or a television program). In particular embodiments, the avail object creator system 205 includes an avail object creation tool 400 that is configured to identify and define objects in video content that may be used to display ad objects. Further, in particular embodiments, the ad object creator system 208 includes an ad object creation tool 500 that is configured to create ad object that can be inserted into video content. The module and tools 400, 500, 600 are described in more detail below.

### Avail Object Creation Tool

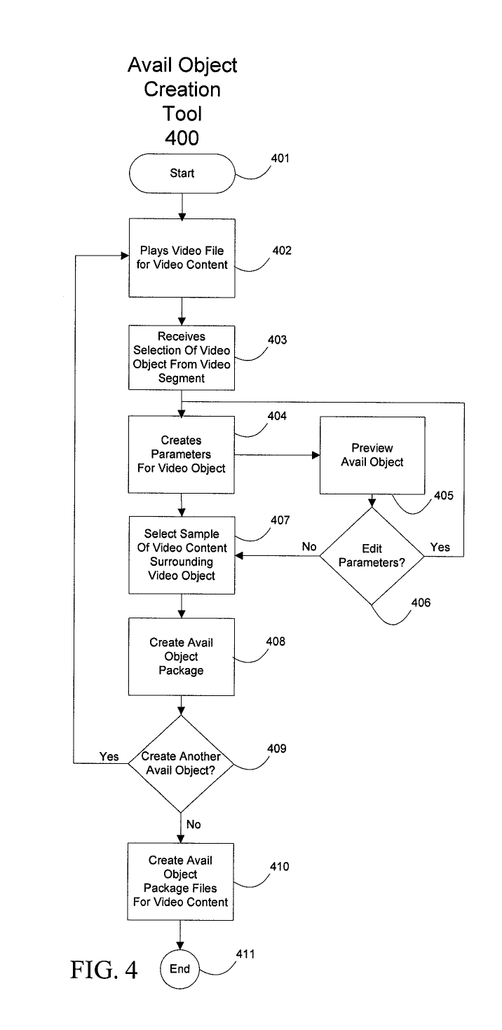

FIG. 4 illustrates a flow diagram of an avail object creation tool 400 according to various embodiments. This flow diagram may correspond to the steps carried out by a processor in a server that resides in the avail object creator system 205 depicted in FIG. 2 as it executes the tool 400 in the server's RAM memory according to various embodiments. In particular embodiments, the server may also include decoders and other equipment to facilitate video processing (such as decoding compressed video files).

In various embodiments, the avail object creation tool 400 incorporates a GUI that allows the avail object creator to review video content (such as a movie file) and identify video objects in the content that may be used to display ad objects. Further, the avail object creation tool 400 is configured to facilitate the avail object creator entering parameters for each of the video objects to create avail objects.

Turning to FIG. 4, in various embodiments, the avail object creator reviews the video content (e.g., movie file) by using avail object creation tool 400. In particular embodiments, the avail object creator opens the video content file and selects a “play” button to watch the video and the avail object creation tool 400 plays the video on a display in communication with the server, shown as Step 402. During the review of the video, the avail object creator sees an object in one of the scenes of the video that he or she would like to define for an avail object. For example, the avail object creator sees a billboard displayed in the background of a scene. The avail object creator stops the review of the video and positions the video to a point in which the object first appears (e.g., rewinds the video to the first frame in which the object appears). At this point, the avail creator selects the object on the screen. For instance, in one embodiment, the avail object creation tool 400 provides the avail object creator with a window that can be dragged and dropped and resized around the object to define the boundaries of the object. For example, the avail object creator is provided with a box that is dragged and dropped over the billboard in the scene and resized to fit around the billboard. As will be understood by those of ordinary skill in the art, the window can be any arbitrary shape according to various embodiments. Further, the avail object creation tool 400 may provide the avail object creator with various shaped windows (such as, for example, square, rectangle, circle, polygon) to choose from based on the object the avail object creator would like to identify in the scene.

Once the avail object creator has position the window around the object (e.g., defined the boundaries of the object), the avail object creator selects a button to signal to the avail object creation tool 400 to begin to track the object in the video. In various embodiments, the avail object creation tool 400 may include image processing software that is configured to automatically track the object's movements through multiple frames of the video and to define the boundaries of the object. In other embodiments, the avail object creation tool 400 may not include such software and the avail object creator is required to track the movements manually by moving the window to match the movements and the boundaries of the object through the multiple frames of the video. Thus, in Step 403, the avail object creation tool 400 receives the selection of the object from the video file.

Further, in Step 404, the avail object creation tool 400 generates one or more parameters that define the object (e.g., avail object). In various embodiments, the avail object creation tool 400 generates parameters as a result of tracking the object over the scene in the video. For instance, the avail object creation tool 400 records the boundaries, shape, motion, and texture of the object through the multiple frames of the video. In addition, in various embodiments, the avail object creation tool 400 records additional parameters such as perspective changes of the object through the multiple frames and/or the color palette used by the object over the multiple frames. Further, in various embodiments, the avail object creation tool 400 may receive parameters as input entered by the avail object creator. For instance, examples of the variables defined for a particular avail object may include: (1) the SMPTE time code (or other unique identifier) of the frames in which the object appears; (2) a bitmap (or equivalent) representing a layer of a single video frame (all pixels in this bitmap may be transparent except for the area to be replaced); (3) a spatial orientation of the object to be replaced; (4) a color palette to be used (as defined in the target video format, for example, MPEG-2 spec); and (5) a motion vector showing the direction of motion of the object from frame to frame.

Once the avail object creation tool 400 has generated all of the parameters for the avail object, in Step 405, the avail object creator may review the avail object. Thus, the avail object creation tool 400 is configured to display the avail object along with or without a stock ad object. In particular embodiments, the avail object creation tool 400 may include a number of “generic” stock ad objects that can be used to review avail objects so that the avail object creator can see what the content will look like once an ad object has been inserted for the particular object. In Step 406, the avail object creation tool 400 receives input from the avail object creator as to whether he or she would like to edit the parameters based on the review of the avail object. If the avail object creator wants to edit the parameters, the avail object creator selects an option on the review screen to edit the parameters and the avail object creation tool 400 returns to the screen(s) that facilitates the avail object creator defining the parameters, at Step 404. If the avail object creator does not want to edit the parameters, the avail object creator selects an option to save the avail object and the avail object creation tool 400 selects a sample of the video content surrounding the video object in the video segment, at Step 407. This sample of content is saved along with the parameters for the particular avail object. Finally, in Step 408, the avail object creation tool 400 creates an avail object package for the avail object by saving the parameters and the sample of content for the particular avail object. In various embodiments, the avail object creation tool 400 may save the parameters and the sample of the content to one or more files or may temporarily save the parameters and the sample of the content in memory. At this point, the avail object creator has created an avail object package for the particular object in the video content. Further, in particular embodiments, the avail object creation tool 400 also assigns a unique identifier to the package. This unique identifier may be used to identify (e.g., reference) the particular avail object package. As is described in greater detail below, in various embodiments, this avail object package is used to help identify an ad object to insert into the, content for the particular object and is used to help locate the object in the content so that the object can be replaced with the ad object.

In Step 409, the avail object creator indicates whether he or she would like to create another avail object for the video. For instance, in one embodiment, the avail object creator selects a button that indicates to the avail object creation tool 400 that the avail object creator would like to continue to review the video. Thus, the avail object creation tool 400 receives the input and returns to the screen(s) associated with Step 402 so that the avail object creator may continue to review the video and select another object.

Once the avail object creator has completed creating avail objects for the video content, the avail object creation tool 400 creates one or more avail object package files for the content, at Step 410. In particular embodiments, these files include the entire avail object packages created for the video content. For instance, in one embodiment, the avail object package files include one file that provides a listing of the avail objects that have been created for the particular video content (e.g., the unique identifiers for the avail objects). This listing lists the avail objects sequentially as they appear in the video content and provides information on how to locate the objects for the avail objects in the video content. For example, the information may include a starting time code and an ending time code in the content, as well as the object's boundaries, shape, motion, and texture. (In various embodiments, the time code identifies a frame in the content by hour, minute, second and frame number.) As is described in more detail below, this information is used in various embodiments to locate the object in the video content and replace the object with a selected ad object. Further, in various embodiments, the avail object package files may also include additional files that store the parameters and the sample of the video content surrounding the object in the content.

Finally, it should be understood that in various embodiments the avail object creation tool 400 is also configured to read and edit avail objects from existing avail object package files. Thus, in various embodiments, the avail object creator may upload existing avail object package files so that he or she can edit existing avail objects and/or create new avail objects for particular video content.

Ad Object Creation Tool

In various embodiments, the ad object creation tool 500 may be incorporated into the same software and/or hardware components along with the avail object creation tool 400 or may be in separate software and/or hardware components. Further, in various embodiments, the ad object creation tool 500 also incorporates a GUI that allows an ad object creator to create ad objects that may be inserted into video content for identified avail objects.

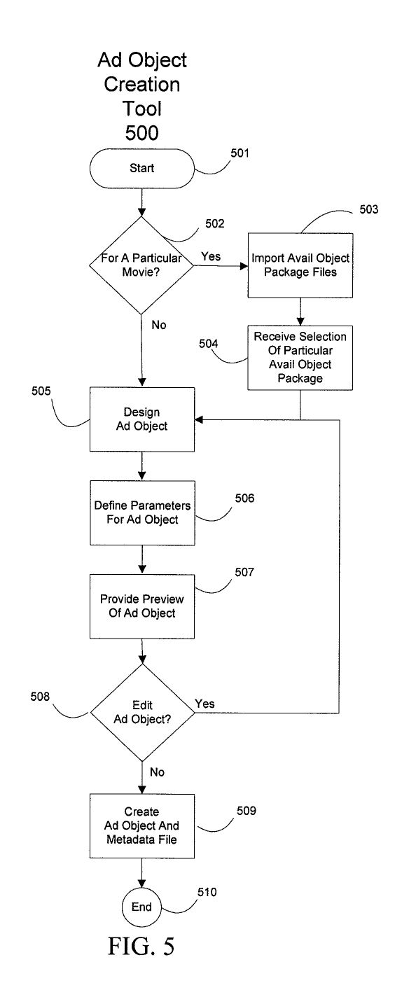

Thus, FIG. 5 illustrates a flow diagram of an ad object creation tool 500 according to various embodiments. This flow diagram may correspond to the steps carried out, for instance, by a processor in a server that resides in the ad object creator system 208 depicted in FIG. 2 as it executes the tool 500 in the server's RAM memory according to various embodiments.

In Step 502, the ad object creator enters into an initial screen and indicates whether he or she is creating an ad object for particular content (e.g., for a particular movie or television program). For instance, in one embodiment, the ad object creator selects a button on the initial screen to import avail object package files associated with a particular video content. Thus, the ad object creation tool 500 receives input indicating that the ad object creator wishes to import avail object package files. In particular embodiments, the ad object creation tool 500 provides a browser tool that is configured to allow the ad object creator to browse to the storage location of the avail object package files. Accordingly, the ad object creator uses the browser tool and browses to the location of the avail object package files and selects the “open” button. In response, the ad object creation tool 500 imports the avail object package files, shown as Step 503. In various embodiments, the ad object creation tool 500 displays the available avail objects stored in the uploaded avail object package files on a screen for the ad object creator to select from.

For instance, the ad object creator may want to create an ad object for a movie that was released five years ago and is being made available through a content service provider's video on demand (VOD) system. The distributor of the movie may have entered into a contract with a car manufacturer to display an ad object for the manufacturer's new sports car in the movie. Therefore, the ad object creator may wish to create a new ad object for the sports car. In this case, the ad object creator uploads the avail object package files for the movie. In response, the ad object creation tool 500 displays a screen listing four available avail objects that have been created for the movie. The four available avail objects include objects in the movie for: (1) a cola can sitting on a table in one scene; (2) a building wall appearing in another scene; (3) an ad appearing on the back of a magazine in another scene; and (4) a television commercial playing on a television in the background of another scene. The ad object creator reviews the four available avail objects and selects the avail object associated with the building wall. Thus, in Step 504, the ad object creation tool 500 receives the ad object creator's selection of the avail object and corresponding avail object package.

In response to the ad object creator selecting a particular avail object or in response to indicating that he or she is not making an ad object for a particular video content, the ad object creation tool 500 displays one or more screens configured to facilitate the ad object creator designing the ad object, shown as Step 505. Thus, the ad object creator creates (or imports) the ad object using the ad object creation tool 500. In various embodiments, the ad object creation tool 500 may be configured to work in conjunction with graphic art software or may be configured to include the functions found in graphic art software to allow the ad object creator to design the ad object. Therefore, the ad object creation tool 500 may be configured as an add-in to use along with graphic art software or may be configured as a stand-alone software package that provides all of the capabilities necessary to create ad objects.

As mentioned, the design step may entail the ad object creator designing the ad object to fit a particular avail object or may entail designing the ad object as “generic” to fit several avail objects. Thus, if the ad object creator is creating the ad object to fit a particular avail object, the ad object creation tool 500 reads the parameters from the avail object package. The ad object creator can then use these parameters to help design the ad object for the particular avail object. For example, in particular embodiments, the ad object creation tool uses the defined parameters to enable the ad object creator to generate the ad object into each frame in which the object appears by resizing the boundaries of the ad object to match the boundaries of the object, apply the correct spatial orientation, color palette and motion blur to the ad object. Further, in particular embodiments, the completed ad object is identified as compatible with the particular avail object.

For instance, returning to the example, the ad object creation tool 500 reads the parameters from the avail object package for the avail object associated with the building wall. The parameters may define the boundaries of the building wall in each frame of the video sequence in which the wall is displayed in the movie. Further, in various embodiments, the ad object creation tool 500 may also use the parameters as constrains for designing the ad object. For instance, the parameters may also include a color palette and the ad object creation tool 500 only allows the ad object creator to use colors from the color palette in designing the ad object to display on the wall. Thus, the ad object creator uses this information provided in the parameters in designing the ad object to display on the building wall in the movie.

In Step 506, the ad object creator defines parameters for the ad object and the ad object creation tool 500 generates the parameters as input. For instance, various parameters may be generated automatically as the ad object creator designs the ad object (such as the dimensions and color palette of the ad object). Other parameters may be entered directly by the ad object creator, such as what colors in the ad object are “locked” and cannot be changed or what historical time period the ad object fits into (such as 1950's or 1970's).

Further, in various embodiments, the ad object creation tool 500 is configured to provide one or more screens that allow the ad object creator to preview the ad object. Therefore, in Step 507, the ad object creation tool 500 provides a preview of the ad object designed by the ad object creator. In particular embodiments in which the ad object has been created for a particular avail object, the ad object creation tool 500 is further configured to use the sample of video content surrounding the object from the avail object package to display the ad object as it will appear in the video content. Thus, in the example, the ad object creation tool 500 displays the sports car ad object designed by the ad object creator on the building wall in the scene from the movie.

After the ad object creator has previewed the ad object, the ad object creator may indicate whether he or she would like to edit the ad object. Therefore, in various embodiments, the ad object creation tool 500 receives input entered by the ad object creator, shown as Step 508. For instance, in one particular embodiment, the ad object creation tool 500 may provide two buttons on the ad object preview screen. The first button may indicate “save ad” and the second button may indicate “edit ad.” Therefore, if the ad object creator does want to edit the ad object, he or she selects the “edit ad” button on the preview screen. In response, the ad object creation tool 500 returns to the design screen(s), shown as Step 505. If the ad object creator does not want to edit the ad object, he or she selects the “save ad” button on the preview screen. In response, in Step 509, the ad object creation tool 500 creates one or more ad object files and metadata files for the ad object. These files contain the ad object created by the ad object creator along with the parameters associated with the ad object. In addition, these files may include an indicator that identifies a particular avail object package if the ad object was created for the particular avail object package, such as, for example, the unique identifier for the avail object package. As is described in more detail below, these files are used in conjunction with the avail object packages in various embodiments to insert ad objects into video content.

Finally, it should be understood that in various embodiments the ad object creation tool 500 is also configured to read and edit existing ad objects. Thus, in various embodiments, the ad object creator may upload existing ad object files and metadata files so that he or she can edit existing ad objects.

### Ad Object Selection Module

In various embodiments, the ad object selection module 600 resides in a system that is configured to distribute video content. For instance, in particular embodiments, the ad object selection module 600 resides in a service provider's system 204 as shown in FIG. 2. In these particular embodiments, the ad object selection module 600 assists in selecting an appropriate ad object to insert into video content the content provider intends to broadcast (and/or unicast) over its distribution network 202. Further, in particular embodiments, the ad object selection module 600 may work in conjunction with software and/or hardware components that insert the ad object into the video content. For example, the service provider system 204 shown in FIG. 2 includes a replacement system 107. This replacement system 107 is configured to receive an ad object from the ad object selection module 600 and to insert the ad object into the content.

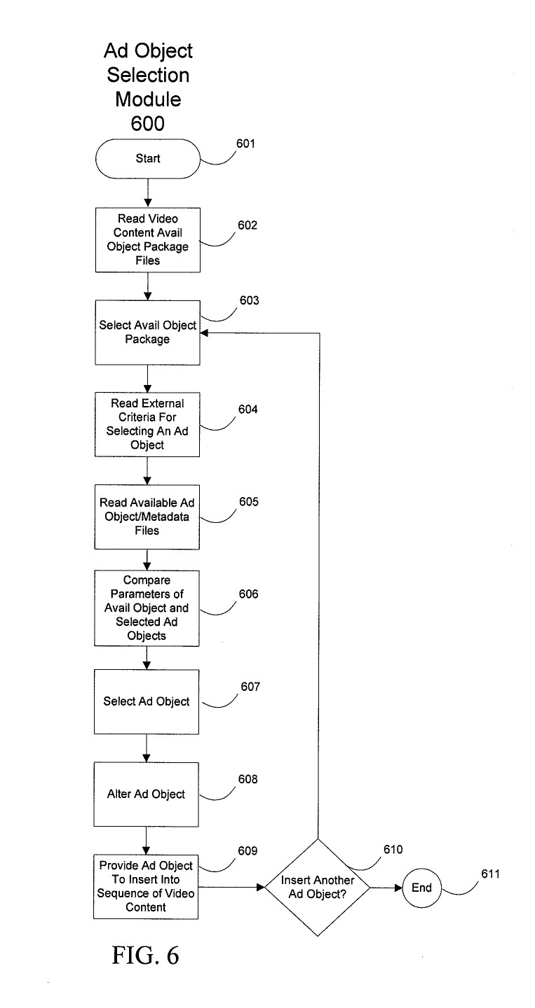

Thus, FIG. 6 illustrates a flow diagram of an ad object selection module 600 according to various embodiments. This flow diagram may correspond to the steps carried out, for instance, by the processor 60 in the server 300 depicted in FIG. 3 as it executes the module 600 in the server's RAM memory 67 according to various embodiments.

In various embodiments, video content (e.g., a movie or television program) and the content's avail object package files are provided to a content provider, such as a cable service provider. The provider schedules to broadcast the content over its distribution network 202 and sets up its system 204 to accommodate. Thus, at the scheduled time, the provider's system 204 begins to deliver the content to the headend 203 to stream the content over its distribution network 202.

In particular embodiments, the system 204 may institute a lag time between the ad object selection module 600 processing the avail object packages for the content and the system 204 delivering the content to be streamed over the provider's distribution network 202. This lag time is built into the system 204 so that the ad object selection module 600 can process the avail object packages and provide selected ad objects to the replacement system 107 with enough time for the replacement system 107 to insert the ad objects into the content before the content is streamed over the distribution network 202.

At Step 602, the ad object selection module 600 reads the avail object package files for the particular content. As previously described, in various embodiments, the avail object package files include a listing of the avail object packages and an indication of the order in which the objects associated with the avail object packages appear in the content. For example, in one embodiment, the avail object package files include a file that list the avail objects sequentially in the order in which the objects the avail objects correspond to appear in the content. Therefore, at Step 603, the ad object selection module 600 selects an avail object package from the file.

At Step 604, the ad object selection module 600 accesses and reads advertising campaign criteria for selecting an ad object for the particular avail object. For instance, in various embodiments, the advertising campaign criteria may be stored in a database that is in communication with the ad object selection module 600. For example, the advertising campaign criteria may be stored in the ad campaign storage 209 shown in the configuration of systems 200 depicted in FIG. 2. Thus, in various embodiments, the advertising campaign criteria may be stored and managed internally or externally with respect to the provider's system 204. In these particular embodiments, the ad object selection module 600 queries the database to obtain the criteria. For instance, in various embodiments, the avail object may provide parameters for the ad object selection module 600 to use in querying the database. Such as, for example, the title of the video content and an identifier for the particular avail object (e.g., the unique identifier for the particular avail object package). The advertising campaign criteria may provide several parameters that the ad object selection module 600 uses to select an ad object for the particular avail object. For instance, the criteria may directly identify an ad object to use for the avail object. For example, the criteria may indicate that an ad object for a certain customer (e.g., Coca Cola®) should be selected from the customer's ad objects that are available. In other examples, the criteria might indicate that an ad object for a certain product should be selected such as a soft drink ad or a car ad.

At Step 605, the ad object selection module 600 reads the ad object/metadata files for the available ad objects. Similar to the selection criteria, in various embodiments, these files may be stored internal or external to the provider's system. For example, the files may be stored in the ad storage 206 depicted in FIG. 2. Further, in various embodiments, a database may be used to organize these files. Therefore, in these particular embodiments, the ad object selection module 600 may query the database to locate the available files and/or to narrow down the available files. For instance, in various embodiments, the ad object selection module 600 may use parameters obtained from the advertising campaign criteria for querying the ad objects to identify the available ad objects and corresponding files. For example, the ad object selection module 600 may query the database to locate all of the files for the available Coca Cola® ad objects. The ad object selection module 600 then obtains the metadata (e.g., parameters) from the files. In various embodiments, the ad object selection module 600 uses these parameters in selecting the appropriate ad object for the particular avail object.

At Step 606, the ad object selection module 600 compares the parameters read from the avail object package, the advertising campaign criteria, and/or the ad object /metadata files. In various embodiments, the ad object selection module 600 performs this comparison to identify an appropriate ad object for the particular avail object. Thus, at Step 607, the ad object selection module 600 selects an ad object for the particular avail object as a result of the comparison process.

In various embodiments, at Step 608, the ad object selection module 600 may alter the ad object based on parameters and/or on the sample of video content surrounding the object read from the avail object package. For instance, in particular embodiments, the ad object selection module 600 may add shading, color, and/or perspective so that the ad object “fits” within the particular movie scene the ad object is to be displayed in.

At Step 609, the ad object selection module 600 provides the ad object to the replacement system 107 along with adequate information so that the replacement system 107 can determine which object to replace with the ad object and how to locate the object in the video content. For instance, in particular embodiments, the ad object selection module 600 provides the replacement system 107 with such information as the starting time code and the ending time code in the content, and the object's boundaries, shape, motion, and texture. As a result, the replacement system 107 locates the object in the appropriate sequence of the video content and replaces the object in the sequence with the ad object provided by the ad object selection module 600. The provider's system 204 then provides the content to the headend 203 to stream over the provider's distribution network 202 with the ad object. As a result, an individual watching the movie will see the ad object displayed in the sequence of the movie in which the object appears in place of the object. For example, the individual will see the sports car ad object on the side of the building wall when that portion of the movie is viewed.

Continuing, at Step 610, the ad object selection module 600 determines whether to select another ad object to be inserted into the content. For instance, in various embodiments, the ad object selection module 600 reads the avail object package files to determine whether another avail object package is listed in the files. If so, the ad object selection module 600 selects the next avail object package, shown as Step 603. If not (e.g., end-of-file reached), the ad object selection module 600 finishes processing the avail object package files for the movie. It should be noted that in various embodiments the ad object selection module 600 may process each avail object package for the content entirely and may provide the ad objects for each avail object to the replacement system 107 to insert into the content prior to the provider's system 204 providing the content to stream over its distribution network 202. While in other embodiments, the ad object selection module 600 may process the avail object packages on-the-fly while the provider's system 204 is in the process of providing the content to stream over its distribution network 202.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

What is claimed is:

1. A system for providing an ad object to replace an object in a video file comprising:
memory; and
a processor adapted to:
obtain an avail object package representing the object in the video file, the avail object package comprising one or more parameters identifying and describing the object;
obtain one or more ad object packages, each ad object package comprising a candidate ad object and one or more parameters describing the candidate ad object; and
select the ad object to replace the object in the video file from the one or more candidate ad objects based on comparing the one or more parameters identifying and describing the object and the one or more parameters describing the candidate ad objects, wherein the ad object is provided with corresponding identifying information to locate the object in the video file so that the object can be replaced with the selected ad object and the selected ad object is transmitted in place of the object in the video file.

2. The system of claim 1, wherein the processor is further adapted to:
obtain one or more advertising campaign parameters providing criteria for selecting the ad object to replace the object in the video file; and
select the ad object to replace the object in the video file from the one or more candidate ad objects based on comparing the one or more parameters identifying and describing the object, the more or more advertising campaign parameters, and the one or more parameters describing the candidate ad objects.

3. The system of claim 2, wherein the processor is adapted to obtain the one or more advertising campaign parameters by querying a storage medium using at least one or more of the parameters describing the object as search criteria and the storage medium comprises advertising campaign parameters associated with one or more different advertising campaigns.

4. The system of claim 2, wherein the processor is adapted to obtain the one or more ad object packages by querying a storage medium using at least one or more of the parameters describing the object and at least one or more of the advertising campaign parameters.

5. The system of claim 1, wherein the corresponding identifying information comprises at least one or more of the parameters identifying the object and at least one or more parameters describing the ad object.

6. The system of claim 1, wherein the corresponding identifying information comprises: (1) a SMPTE time code defining a segment of the video file that comprises one or more video frames in which the object appears; (2) boundaries of the object in each of the one or more video frames; (3) a spatial orientation of the video object; (4) a color palette; and (5) a motion vector showing a direction of motion of the video object over the segment of the video file.

7. The system of claim 1 further comprising:
a replacement system adapted to:
locate the object in the video file based on the corresponding identifying information;
alter the selected ad object based on the corresponding identifying information; and
replace the object in the video file with the altered ad object; and
a headend adapted to:
stream the video file over a distribution network, wherein the video file is displayed to one or more users in communication with the distribution network with the altered ad object in place of the object.

8. A method for providing an ad object to replace an object in a video file, the method comprising the steps of:
obtaining, via a computer device, an avail object package from memory, the avail object package representing the object in the video file and comprising one or more parameters identifying and describing the object;
obtaining, via the computer device, one or more ad object packages from the memory, each ad object package comprising a candidate ad object and one or more parameters describing the candidate ad object; and
selecting the ad object to replace the object in the video file from the one or more candidate ad objects, via the computer device, based on comparing the one or more parameters identifying and describing the object and the one or more parameters describing the candidate ad objects, wherein the ad object is provided with corresponding identifying information to locate the object in the video file so that the object can be replaced with the selected ad object and the selected ad object is transmitted in place of the object in the video file.

9. The method of claim 8 further comprising the steps of:
obtaining, via the computer device, one or more advertising campaign parameters from the memory, the one or more advertising campaign parameters providing criteria for selecting the ad object to replace the object in the video file; and
selecting the ad object to replace the object in the video file from the one or more candidate ad objects, via the computer device, based on comparing the one or more parameters identifying and describing the object, the more or more advertising campaign parameters, and the one or more parameters describing the candidate ad objects.

10. The method of claim 9, wherein the step for obtaining the one or more advertising campaign parameters by querying a storage medium using at least one or more of the parameters describing the object as search criteria and the storage medium comprises advertising campaign parameters associated with one or more different advertising campaigns.

11. The method of claim 9, wherein the step of obtaining the one or more ad object packages is performed by querying the memory using at least one or more of the parameters describing the object and at least one or more of the advertising campaign parameters.

12. The method of claim 8, wherein the corresponding identifying information comprises at least one or more of the parameters identifying the object and at least one or more parameters describing the ad object.

13. The method of claim 8, wherein the corresponding identifying information comprises: (1) a SMPTE time code defining a segment of the video file that comprises one or more video frames in which the object appears; (2) boundaries of the object in each of the one or more video frames; (3) a spatial orientation of the video object; (4) a color palette; and (5) a motion vector showing a direction of motion of the video object over the segment of the video file.

14. The method of claim 8 further comprising the steps of:
locating the object in the video file based on the corresponding identifying information;
altering the selected ad object based on the corresponding identifying information;
replacing the object in the video file with the altered ad object; and
streaming the video file over a distribution network, wherein the video file is displayed to one or more users in communication with the distribution network with the altered ad object in place of the object.

15. A system for providing an avail object package representing an object in a video file to be replaced with an ad object, the system comprising:
a processor adapted to:
play the video file, the video file comprising a file for video content;
receive selection of the object in the video file, the object comprising an entity in the video file that appears over a segment of the video file, the segment comprises one or more video frames;
obtain one or more parameters defining properties of the object; and
create the avail object package by saving the one or more parameters defining properties of the object in one or more files, wherein an ad object to replace the object in the video file is selected or created based on the one or more parameters defining properties, and the object is located in the video file based on the one or more parameters defining properties of the object so that the object can be replaced with the ad object and the ad object is transmitted in place of the object in the video file.

16. The system of claim 15, wherein the one or more parameters comprise (1) a SMPTE time code defining the segment in which the object appears; (2) boundaries of the object in each of the one or more video frames; (3) a spatial orientation of the video object; (4) a color palette; and (5) a motion vector showing a direction of motion of the video object over the segment of the video file.

17. A method for providing an avail object package representing an object in a video file to be replaced with an ad object, the method comprising the steps of:
playing the video file on a display in communication with a computer device, the video file comprising a file for video content;
receiving selection of the object in the video file from an input device in communication with the computer device, the object comprising an entity in the video file that appears over a segment of the video file, the segment comprises one or more video frames;
obtaining one or more parameters defining properties of the object; and
creating the avail object package, via the computer device, by saving the one or more parameters defining properties of the object in one or more files, wherein an ad object to replace the object in the video file is selected or created based on the one or more parameters defining properties, and the object is located in the video file based on the one or more parameters defining properties of the object so that the object can be replaced with the ad object and the ad object is transmitted in place of the object in the video file.

18. A system for providing an ad object to replace an object in a video file, the system comprising:
memory; and
a processor adapted to:
import an avail object package in the memory, the avail object package comprising one or more parameters defining properties of the object, the object comprising an entity that appears over a segment of the video file, the segment comprising one or more video frames;
design the ad object based on at least one of the one or more parameters defining properties of the object;
obtain one or more parameters defining properties of the ad object; and
create one or more files comprising the ad object and the one or more parameters defining properties of the ad object, wherein the one or more parameters defining properties of the ad object are used to replace the object in the video file with the ad object so that the ad object is transmitted in place of the object in the video file.

19. A method for providing an ad object to replace an object in a video file, the method comprising the steps of:
importing an avail object package in the memory, the avail object package comprising one or more parameters defining properties of the object, the object comprising an entity that appears over a segment of the video file, the segment comprising one or more video frames;
designing the ad object on a graphical user interface based on at least one of the one or more parameters defining properties of the object;
obtaining one or more parameters defining properties of the ad object; and
creating one or more files comprising the ad object and the one or more parameters defining properties of the ad object, wherein the one or more parameters defining properties of the ad object are used to replace the object in the video file with the ad object so that the ad object is transmitted in place of the object in the video file.
